(19) United States
(12) Patent Application Publication
(10) Pub. No.: US 2020/0283159 A1
(43) Pub. Date: Sep. 10, 2020

(54) CONNECTION STRUCTURE, POWER SYSTEM AND UNMANNED AERIAL VEHICLE

(71) Applicant: SZ DJI TECHNOLOGY CO., LTD., Shenzhen (CN)

(72) Inventors: Jianda QIU, Shenzhen (CN); Ye TAO, Shenzhen (CN)

(21) Appl. No.: 16/877,041

(22) Filed: May 18, 2020

Related U.S. Application Data
(63) Continuation of application No. PCT/CN2017/113895, filed on Nov. 30, 2017.

(51) Int. Cl. B64D 27/24; B64C 39/02; B60L 15/20; B64D 31/14

(52) U.S. Cl. CPC B64D 27/24; B64C 39/024; B60L 15/20; B64C 2201/108; B64C 2201/042; B60L 2200/10; B64D 31/14

(57) ABSTRACT

A connection structure includes a supporting platform and a receiving sleeve. A first side of the supporting platform is configured to support an electronic speed controller (ESC) and a motor for driving a propeller. The receiving sleeve is disposed on a second side of the supporting platform and configured to receive and fix an arm.

### CROSS-REFERENCE TO RELATED APPLICATION

This application is a continuation of International Application No. PCT/CN2017/113895, filed on Nov. 30, 2017, the entire content of which is incorporated herein by reference.

### TECHNICAL FIELD

The present disclosure relates to the connection device technology and, more specifically, to a connection structure, a power system, and an unmanned aerial vehicle (UAV).

### BACKGROUND

Generally, the power system of a UAV can include a propeller, a motor, an electronic speed controller (ESC), an arm, and a first member and a second member that assemble the propeller, motor, ESC, and arm as a whole.

In conventional technology, the structure of the power system mainly includes two parts. One part can be fixed to the motor (the propeller can be arranged on the motor) by using the first member, and the other part can be fixed to the arm by using the second member. Further, the first member and the second member can be connected and fixed, and the ECS can be housed in a cavity formed by the first member and the second member.

However, since the arm needs to be fixedly connected to the motor through the first member and the second member, the reliability of the power system may be reduced. At the same time, the first member and the second member need to cooperate to form the cavity, which makes the structure more complicated, thereby increasing the processing features and the production costs.

### SUMMARY

A first aspect of the present disclosure provides a connection structure including a supporting platform and a receiving sleeve. A first side of the supporting platform is configured to support an electronic speed controller (ESC) and a motor for driving a propeller. The receiving sleeve is disposed on a second side of the supporting platform and configured to receive and fix an arm.

A second aspect of the present disclosure provides a power system including a propeller; a motor connected to the propeller; an electronic speed controller (ESC); and a connection structure. The connection structure includes a supporting platform and a receiving sleeve. A first side of the supporting platform is configured to support an electronic speed controller (ESC) and a motor for driving a propeller. The receiving sleeve is disposed on a second side of the supporting platform and configured to receive and fix an arm.

A third aspect of the present disclosure provides an unmanned aerial vehicle (UAV) including a main body; an arm; and a power system connected to the arm. The power system includes a propeller; a motor connected to the propeller; an electronic speed controller (ESC); and a connection structure. The connection structure includes a supporting platform and a receiving sleeve. A first side of the supporting platform is configured to support an electronic speed controller (ESC) and a motor for driving a propeller. The receiving sleeve is disposed on a second side of the supporting platform and configured to receive and fix an arm.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a diagram of a connection structure according to an embodiment of the present disclosure.

FIG. 2 is a cross-sectional view of the connection structure according to an embodiment of the present disclosure.

FIG. 3 is an exploded diagram of a power system structure according to an embodiment of the present disclosure.

FIG. 4 is a diagram of a heat dissipating structure in the connection structure according to an embodiment of the present disclosure.

### DETAILED DESCRIPTION OF THE EMBODIMENTS

The embodiments of the present disclosure provide a connection structure, a power system, and a UAV, which are used to increase the connection reliability of the power system of the UAV, simplify the structure of the power system, and reduce the production costs.

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The terms “first,” “second,” “third,” “fourth,” and similar expressions used herein (if present) are used to distinguish similar objects without the necessity of describing a specific order or sequence. It is to be understood that the data so used may be interchanged where appropriate, so that the embodiments described herein can be implemented in sequences other than what is illustrated or described herein. In addition, terms “include”, “have” and similar expressions are intended to cover non-exclusive inclusions. For example, processes, methods, systems, products or devices containing a series of steps or units are not limited to those clearly shown steps or units, and can include other steps or units not clearly shown, or other inherent steps or units of these processes, methods, products or devices.

Generally, the power system of a UAV mainly includes an electric motor, while an electric power system mainly includes a motor, an ESC, and propellers. In particular, an individual motor needs an ESC to work as the ESC can be used to control the speed of the motor. In practical applications, the ESC can drive the propeller to rotate by driving the motor, and the propeller can be used to generate an upward pulling force. A cooperating motor, ESC, and propellers can consume less power while providing the same thrust, which may improve the flight time of the UAV.

In conventional technology, in order to mount the power system on the arm of the UAV, the power system may include two parts, one of which may be connected to the motor and the other may be connected to the arm. Subsequently, the two parts may be connected and the ESC may be placed in the cavity formed by the two parts, thereby completing the connection between the power system and the arm of the UAV to realize the drive of the UAV power system. It can be seen from the above description, the fixed connection between the arm and the motor needs two parts as an intermediate transition component, which may reduce the connection reliability of the system. At the same time, after the two parts are connected, a cavity structure needs to be formed to house the ESC, thereby increasing the structural complexity of the two parts, which may increase the processing features and the production costs.

An embodiment of the present disclosure provides a connection structure. The connection structure can be used to carry the ESC and the motor, and realize the connection with the arm of the UAV. Relatively speaking, a single component can be used to realize the fixed connection between the arm and the motor, thereby increasing the connection reliability of the system to a certain extent, simplifying the power system structure, and reducing the production costs.

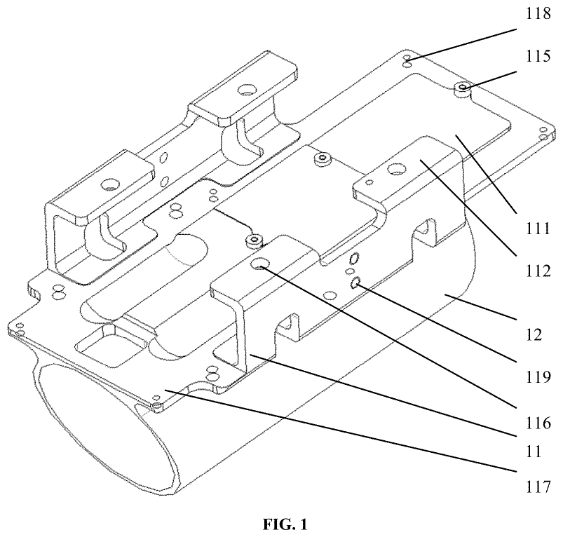

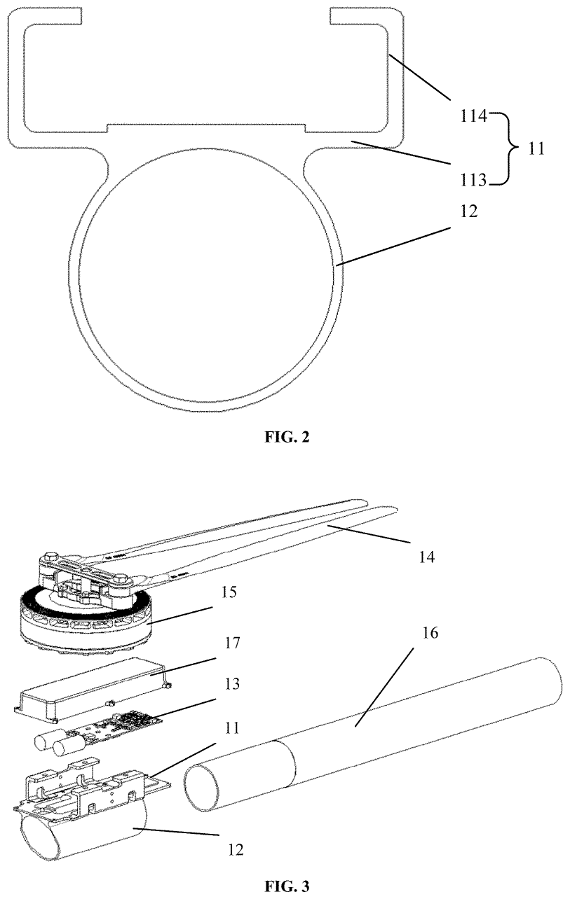

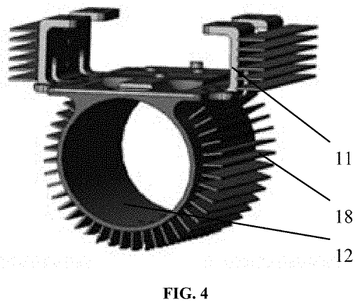

In order to clearly understand the technical solutions of the present disclosure, the connection structure provided in the embodiments of the present disclosure will be described in detail below. Referring to FIG. 1 and FIG. 3, in one embodiment of the present disclosure, the connection structure includes a supporting platform 11 and a receiving sleeve 12. One side of the supporting platform 11 may be used to carry/hold an ESC 13 and a motor 15 for driving a propeller 14, while the receiving sleeve 12 may be disposed on the other side of the supporting platform 11. The receiving sleeve 12 may be used for receiving and fixing an arm 16. The arm 16 may be a mechanical arm.

More specifically, the connection structure may include the supporting platform 11 and the receiving sleeve 12. In particular, the supporting platform 11 may include two side surfaces. One side surface may be used to carry the ESC 13 and the motor 15 (the motor 15 can be connected to the propeller 14), and this side surface can be structurally designed based on the placement, size, and shape of the ESC 13 and the motor 15. The receiving sleeve 12 may be disposed on the other side surface of the supporting platform 11. That is, a part of the outer surface of the receiving sleeve 12 may be used to carry a stable supporting platform 11, and a cavity formed on the inner surface thereof may be used to receive and fix the arm 16. This side surface of the supporting platform 11 can be structurally designed based on the degree of connection stability, the connection area, etc. of the supporting platform 11 and the receiving sleeve 12. The receiving sleeve 12 can be structurally designed based on the shape, size, and connection manner of the arm 16. For example, the receiving sleeve 12 may include a thin-walled structure having the same shape as the outer periphery of the arm 16 along the axial center direction of the arm, so as to hold the arm 16. As such, as the connection structure is connected to the arm 16, the ESC 13, and the motor 15, connection of the power system to the arm 16 of the UAV is accomplished.

In addition, in the embodiments of the present disclosure, due to the structural design of the connection structure, it may be possible process the connection structure using profiles (e.g., pulled aluminum). Since the profile itself has an overall shape and the thickness of its thin wall is relatively uniformed, only a small amount of processing may be needed to complete the production of the connection structure. As such, the amount of cutting in the processing process may be limited, and the material utilization rate may be extremely high, and the processing time may be short, which may further reduce the production costs and improve the production efficiency.

It should be noted that in the embodiments of the present disclosure, in the connection structure, the supporting platform 11 and the receiving sleeve 12 may be an integrated structure (i.e., integrated as a one-piece structure). That is, the supporting platform 11 and the receiving sleeve 12 may not be detachable. For example, the supporting platform 11 and the receiving sleeve 12 may be a one-piece structure or fixed by welding. In practical applications, the supporting platform 11 and the receiving sleeve 12 may also be connected using a predetermined connection method, which may be a detachable structure. For the ease of mounting, the supporting platform 11 and the receiving sleeve 12 may be connected by bolts or by snap-fitting, but the structure of the supporting platform 11 and the receiving sleeve 12 for connecting the arm 16 and the motor 15 may not change. Further, in the case of a detachable connection, the connection structure as a component may still simplify the structure of the power system. Therefore, whether the supporting platform 11 and the receiving sleeve 12 are an integrated structure is not specially limited in the present disclosure.

In some embodiments, in order to enhance the stability of the connection structure and indirectly improve the stable connection between the arm 16 and the motor 15 of the UAV, the supporting platform 11 and the receiving sleeve 12 may be an integrated structure. As such, the relative movement between the supporting platform 11 and the receiving sleeve 12 due to loose connection may be avoided, which may improve the reliability of the connection between the arm 16 and the motor 15.

In the embodiments of the present disclosure, since the supporting platform 11 of the connection structure can carry the ESC 13 and the motor 15 for driving the propeller 14, and the receiving sleeve 12 can receive and fix the arm 16, it can be seen that the connection and fixation of the arm 16 and the motor 15 can be achieved by the connection structure, thereby improving the connection reliability and mounting convenience of the arm 16 and the motor 15. At the same time, compared to the conventional technology, adjusting from two connecting parts to one connecting part not only simplifies the structure of the power system, but also avoids poor production processing caused by the need for the cooperation precision of the two connecting parts, thereby effectively reducing the production costs.

Based on the connection structure provided in the previous embodiments of the present disclosure, refer to FIG. 1 and FIG. 3. In another embodiment of the connection structure of the present disclosure, the supporting platform 11 further includes a first mounting surface 111 and a second mounting surface 112. The first mounting surface 111 may be used for mounting the ESC 13, and the second mounting surface 112 may be used for mounting the motor 15. In addition, the platform height of the first mounting surface 111 may be lower than the platform height of the second mounting surface 112.

More specifically, since one side of the supporting platform 11 needs to carry the ESC 13 and the motor 15, the supporting platform 11 may include the first mounting surface 111 for mounting the ESC 13 and the second mounting surface 112 for mounting the motor 15.

In some embodiments, the first mounting surface 111 and the second mounting surface 112 can be designed based on the mounting position and the mounting area of the ESC 13 and the motor 15. Further, the first mounting surface 111 and the second mounting surface 112 may or may not be at the same horizontal height. However, in practical applications, since the motor 15 needs to be connected with the propeller 14 of the UAV, and the propeller 14 needs a large space to rotate. As such, in some embodiments of the present disclosure, the platform height of the first mounting surface 111 may be lower than the platform height of the second mounting surface 112 to facilitate the driving of the propeller 14 by the motor 15.

In the structure described above, for the platform height of the first mounting surface 111 to be lower than the platform height of the second mounting surface 112, the supporting platform 11 may include a supporting body 113 and a supporting bracket 114. To ensure the stable supporting performance of the supporting platform 11, the supporting body 113 and the supporting bracket 114 may be an integrated structure. In some embodiments, the opposite sides in the vertical direction of the supporting body 113 may be respectively arranged with the supporting bracket 114. In particular, the supporting body 113 may be, for example, a square, such that the supporting body may include four sides. In order to simplify the preparation process of achieve the purpose of stable support, a pair of supporting brackets 114 may be disposed on a pair of side edges, that is, either pair of side edges may be provided with a supporting bracket 114, such that two supporting brackets 114 may respectively provide a supporting surface. The two supporting surfaces can form the second mounting surface 112 for mounting the motor 15 at the same platform height. The first mounting surface 111 provided on the supporting platform 11 for mounting the ESC 13 may be disposed below the second mounting surface 112 to form a mounting position in which the motor 15 and the ESC 13 may overlap each other in a vertical direction, which may facilitate the integration of the mounting space. At the same time, after the propeller 14, motor 15, ESC 13, connection structure, and arm 16 are connected, since the supporting bracket 114 may not expand laterally on the supporting platform 11, it may effectively reduce the size of the UAV.

It should be noted that in the embodiments of the present disclosure, when the supporting body 113 is, for example, a square, the number of the supporting brackets 114 can also be adjusted based on the actual needs. For example, a supporting bracket 114 may be disposed on each side of the supporting body 113, which is not specifically limited herein.

It can be understood that in the embodiments of the present disclosure, in addition to the description provided above, the shape of the supporting body 113 may also be other shapes or designed based on the actual needs in practical applications, as long as the ESC 13 may be mounted thereon. At the same time, the supporting bracket 114 and the second mounting surface 112 may also be designed with different structures, as long as the motor 15 may be mounted thereon, which is not specifically limited herein.

Further, in the embodiments of the present disclosure, in order to provide the second mounting surface 112 with a relatively large mounting area and simplify the production process of the supporting bracket 114, the supporting bracket 114 may have an inverted L-shaped structure. Take the supporting brackets 114 being disposed on the opposite sides of the supporting body 113 as an example, the opening directions of the inverted L-shaped structures can be set to face each other or to be opposite to each other. More specifically, the opening directions of the inverted L-shaped structures may be set based on the relative size of the motor 15 and the ESC 13. For example, when the mounting surface of the motor 15 is larger than the mounting surface of the ESC 13, the opening directions of the inverted L-shaped structures may be opposite to each other (e.g., the top part of each inverted L-shaped structure touching the motor 15 extends outward of the supporting platform 11). Further, when the mounting surface of the motor 15 is not larger than the mounting surface of the ESC 13, the opening directions of the inverted L-shaped structures may be disposed as facing each other (e.g., the top part of each inverted L-shaped structure touching the motor folds inward of the supporting platform 11).

In some embodiments, since the shape of the bottom of the motor 15 may be a circle. As such, the size of the mounting surface formed by the inverted L-shaped structure may have limited effect on the mounting stability of the motor 15, as long as it can provide a plurality of support points to support the motor 15. Therefore, in order to improve the lightweight design of the UAV, the opening directions of the inverted L-shaped structure in the vertical direction in the opposite sides of the supporting body 113 may be disposed as facing each other.

Based on the connection structure described in the previous embodiments of the present disclosure, the assembly method of the ESC 13 and the motor 15 will be described in detail below.

Assembly Method of the ESC 13.

More specifically, at least one first mounting portion 115 may be disposed on the first mounting surface 111 of the supporting platform 11. The first mounting portion 115 may be used to fix the ESC 13 to realize a stable connection between the ESC 13 and the connection structure. In particular, the first mounting portion 115 may be a first screw hole structure, and the ESC 13 may be closely/snugly fixed on the first mounting surface 111 through the cooperation of the bolt and the first screw hole structure.

It can be understood that in the embodiments of the present disclosure, in addition to the description provided above, the structure of the first mounting portion 115 may also adopt other structural designs, such as a snap-fit structure, to connect with the ESC 13, which is not limited herein.

In addition, in order to facilitate the heat dissipation of the ESC 13 and improve the service life of the ESC 13, a thermal conductive material may be disposed between the first mounting surface 111 and the ESC 13. The thermal conductive material may include, but is not limited to, a silicone thermal conductive sheet or a thermal conductive paste. In some embodiments, the silicone thermal conductive sheet may not only complete the heat transfer from the ESC 13 and the supporting platform 11, but may also play the role of insulation and reducing vibration, thereby meeting the design requirements of equipment miniaturization and ultra-thinness, which is beneficial to the refined design of the UAV. In some embodiments, the thermal paste may not only conduct heat, but may also have good usability and construction performance, which may facilitate the simplification process.

Assembly Method of the Motor 15.

More specifically, at least one second mounting portion 116 may be disposed on the second mounting surface 112 of the supporting platform 11. The second mounting portion 116 may be used to fix the motor 15 to realize a stable connection between the motor 15 and the connection structure. In particular, the second mounting portion 116 may be a second screw hole structure, and the motor 15 may be closely fixed on the second mounting surface 112 through the cooperation of the bolt and the second screw hole structure.

It can be understood that in the embodiments of the present disclosure, in addition to the description provided above, the structure of the second mounting portion 116 may also adopt other structural designs, such as a snap-fit structure, to connect with the motor 15, which is not limited herein.

In addition, in the embodiments of the present disclosure, when the supporting bracket 114 is respectively provided on the opposite sides of the supporting body 113, the width of the gap between the supporting surfaces formed by the two supporting brackets 114 may be different based on the assembly method of the ESC 13. In some embodiments, the width of the gap may not be smaller than the size of the ESC 13, as such, the ESC 13 may be placed on the first mounting surface 111 through the gap. In some embodiments, the width of the gap may be smaller than the size of the ESC 13, as such, the ESC 13 may need to be disposed below the second mounting surface 112. For example, the ESC 13 may be inserted from the side of the supporting body 113 without the supporting bracket 114 and be placed on the first mounting surface 111. In practical applications, the width of the gap may be designed as needed, which is not specifically limited herein.

Further, in the embodiments of the present disclosure, when the motor 15 and the ESC 13 are mounted on the mounting position in which the ESC 13 overlaps with the motor 15 in a vertical direction, in order to facilitate the mounting of the ESC 13, the distance (e.g., vertical distance) between the first mounting surface 111 and the second mounting surface 112 may be greater than the height of the ESC 13. As such, when the ESC 13 is mounted using any of the two methods described above, the mounting of the ESC 13 may not be affected by the distance between the first mounting surface 111 and the second mounting surface 112. In some embodiments, the deviation between the distance between the first mounting surface 111 and the second mounting surface 112 and the height of the ESC 13 may be designed based on actual needs, which is not specifically limited herein.

Based on the connection structure provided in the previous embodiments of the present disclosure, refer to FIG. 1 and FIG. 3. In another embodiment of the connection structure of the present disclosure, the supporting platform 11 further includes a third mounting surface 117, which surrounds the outer periphery of the first mounting surface, the third mounting surface may be used for mounting a protective cover 17 for protecting the ESC 13.

More specifically, since the ESC 13 is important for the use of the motor 15, the ESC 13 may be protected, which may not only improve the service life of the ESC 13, but also maintain the use of the motor 15. Therefore, the supporting platform 11 may further include the third mounting surface 117, which may be used for mounting the protective cover 17. The receiving space formed by the protective cover 17 and the third mounting surface 117 may be used for receiving the ESC 13. Further, the third mounting surface 117 may be designed to surround the outer periphery of the first mounting surface 111 on the supporting platform 11.

In some embodiments, in order for the protective cover 17 to physically protect the ESC 13 and prevent dust and water, a cooperation structure of the protective cover 17 and the third mounting surface 117 may be a sealed waterproof structure. At the same time, in order to facilitate the observation of the working state of the ESC 13, the protective cover 17 may be made of a transparent or translucent material, such that the state of the ESC 13 such as the indicator light inside the protective cover 17 may be seen through the protective cover to determine whether the ESC 13 is abnormal. As such, when the power system of the UAV fails, it may be possible to determine whether the failure is caused by the ESC 13 without removing the protective cover 17, thereby improving the maintenance efficiency of the power system.

It should be noted that, in the embodiments of the present disclosure, in addition to the transparent or translucent material described above, in practical application, the protective cover 17 may also adopt other structures. For example, a transparent or translucent window may be disposed on the protective cover 17 at a corresponding position for observing the working state of the ESC 13, but other parts of the protective cover 17 except the transparent or translucent window may be made of non-transparent material, which is not specifically limited herein.

It can be understood that, in the embodiments of the present disclosure, when the supporting bracket 114 is respectively provided on the opposite sides of the supporting body 113, the width of the gap between the supporting surfaces formed by the two supporting brackets 114 may be different based on the assembly method of the protective cover 17. As such, the width of the gap may be based on the size of the protective cover 17. For details, reference may be made to the similar content described above, and details will not be described herein again.

Further, if the protective cover 17 is mounted on the supporting platform 11, when the motor 15 and the ESC 13 are mounted on the mounting position in which the ESC 13 overlaps with the motor 15 in a vertical direction, in order to facilitate the mounting of the ESC 13 and the protective cover 17, the distance between the first mounting surface 111 and the second mounting surface 112 may be greater than the height of the protective cover 17. As such, the mounting of the protective cover 17 may not be affected by the distance between the first mounting surface 111 and the second mounting surface 112. In some embodiments, the deviation between the distance between the first mounting surface 111 and the second mounting surface 112 and the height of the protective cover 17 may be designed based on actual needs, which is not specifically limited herein.

Furthermore, at least one third mounting portion 118 may be disposed on the third mounting surface 117 of the supporting platform 11. The third mounting portion 118 may be used for fixing the protective cover 17 to achieve a stable connection between the protective cover 17 and the connection structure, and to realize the tightness of the cooperation structure of the protective cover 17 and the third mounting surface 117. In some embodiments, the third mounting portion 118 may be a third screw hole structure, and the protective cover 17 may be fixed on the third mounting surface 117 through the cooperation of the bolt and the third screw hole structure.

It can be understood that, in the embodiments of the present disclosure, in addition to the description provided above, the structure of the third mounting portion 118 may also adopt other structural designs, such as a snap-fit structure, to connect with the protective cover 17, which is not limited herein.

Based on the connection structure provided in the previous embodiments of the present disclosure, refer to FIG. 1. In another embodiment of the connection structure of the present disclosure, the supporting platform 11 further includes a fourth mounting portion 119, the third mounting portion 119 may be used for mounting a predetermined component.

More specifically, UAVs can be used in different fields, such as military, filming, agricultural, industrial, etc., and UAVs can have multiple application scenarios in the same field. Under different application scenarios, the structure of the UAV combined with the application scenarios can be slightly changed and adjusted. In order for the UAV to be reused in different application scenarios, at least one fourth mounting portion 119 may be provided on the supporting platform 11. The fourth mounting portion 119 may be a reserved mounting structure and may be used to mounting a predetermined component. The predetermined component can be determined based on the application scenario of the UAV to meet the needs of applications in different fields. For example, when the UAV needs to be used in the agricultural field, the predetermined component may be, for example, a sprinkler head. In some embodiments, the fourth mounting portion 119 may be a fourth screw hole structure, and the predetermined component may be fixed on the supporting platform 11 through the cooperation of the bolt and the fourth screw hole structure.

It can be understood that, in the embodiments of the present disclosure, in addition to the description provided above, the structure of the fourth mounting portion 119 may also adopt other structural designs, such as a snap-fit structure, to connect with the predetermined component, which is not limited herein.

Based on the connection structure provided in the previous embodiments of the present disclosure, refer to FIG. 3 and FIG. 4. In another embodiment of the connection structure of the present disclosure, the receiving sleeve 12 and the arm 16 may be clearance-fitted, and an adhesive for a fixed connection may be disposed between the receiving sleeve 12 and the arm 16.

More specifically, the inner diameter of the receiving sleeve 12 may be larger than the outer diameter of the arm 16, and the receiving sleeve 12 and the arm 16 may be fitted with a clearance. In order to strengthen the fixed connection between the receiving sleeve 12 and the arm 16, an adhesive may be disposed between the receiving sleeve 12 and the arm 16, such that the inner surface of the receiving sleeve 12 and the outer surface of the arm 16 may be fixed and bonded together through the adhesive.

It can be understood that, in the embodiments of the present disclosure, the receiving length of the receiving sleeve 12 may be reasonably designed based on actual needs, which is not specifically limited herein.

In addition, in the embodiments of the present disclosure, a fifth mounting portion may be provided on the receiving sleeve 12, and the fifth mounting portion may be used to fix the arm 16 to further strengthen the stable connection between the arm 16 and the connection structure based on the use of adhesive. In some embodiments, the fifth mounting portion may be a fifth screw hole structure, and the arm 16 may be fixedly received in the receiving sleeve 12 through the cooperation of the bolt and the fifth screw hole structure.

It can be understood that, in the embodiments of the present disclosure, in addition to the description provided above, the structure of the fifth mounting portion may also adopt other structural designs, such as a snap-fit structure, to connect with the arm 16, which is not specifically limited herein.

It should be noted that, in the embodiments of the present disclosure, the fifth mounting portion may also be used to fix the arm 16 alone, that is, no adhesive may be provided between the receiving sleeve 12 and the arm 16.

In some embodiments, the shape of an end portion (i.e., a port) on the inner surface of the receiving sleeve 12 facing away from the arm 16 may be oval. In practical applications, the shape of the port on the inner surface of the receiving sleeve 12 facing away from the arm 16 may also be other shapes, such as circular. At the same time, the shape of the port on the outer surface of the receiving sleeve 12 facing away from the arm 16 may be oval, circular, or square, etc., and it can be reasonably designed based on actual needs, which is not specifically limited herein.

In some embodiments, in order to maintain the thickness uniformity of the receiving sleeve 12, the shape of the port on the outer surface facing away from the arm 16 may be consistent with the shape of the port on the inner surface, such as oval.

In the embodiments of the present disclosure, since the ESC 13 is closely attached to the first mounting surface 111, the heat dissipation of the ESC 13 will mainly depend on the connection structure, especially the supporting platform 11. As such, the heat generated by the ESC 13 may be conducted to the supporting platform 11 and even the receiving sleeve 12 through a thermal conductive material, and then dissipated to the outside through the surfaces of the supporting platform 11 and the receiving sleeve 12.

In the structure described above, in order to further improve the heat dissipation efficiency, a heat dissipating structure 18 may be provided on the outer periphery of the supporting platform 11 and/or the outer periphery of the receiving sleeve 12. In some embodiments, the heat dissipating structure 18 may be a scaled heat sink structure, that is, a plurality of heat sink scales that are spaced apart may be arranged on the outer periphery of the supporting platform 11 and/or on the outer periphery of the receiving sleeve 12. The heat generated by the ESC 13 can be conducted to the heat dissipating scales arranged on the outer periphery of the supporting platform 11 and/or on the outer periphery of the receiving sleeve 12 through a thermal conductive material, such that heat may be distributed on the heat dissipating scales and lost in the air in a convection manner. Further, the heat dissipating scales may increase the heat dissipating area of the supporting platform 11 and the receiving sleeve 12, thereby achieving the purpose of high-efficiency heat dissipation.

It can be understood that, in the embodiments of the present disclosure, in addition to the heat dissipating scales described above, the structure of the heat dissipating structure 18 may also adopt other structural designs in practical applications, as long as it can assist in achieving a good heat dissipation effect, which is not specifically limited herein.

An embodiment of the present disclosure further provides a power system. Referring to FIG. 3, the power system includes a plurality of propellers 14, a motor 15 connected to the propellers 14, and an ESC 13. At the same time, the power system may further include the connection structure described in the previous embodiments. The connection structure may be used to carry the ESC 13 and the motor 15, and receive the arm 16, thereby realizing the mounting of the power system on the UAV to provide power to the UAV.

In addition, the power system may further include a protective cover 17 for providing physical protection to the ESC 13 and being dustproof and waterproof. The ESC 13 may be disposed inside the receiving space of the protective cover 17. For details related to the design of the protective cover 17, reference may be made to the same content previously provided, and details will not be repeated herein.

When the power system provided in the embodiments of the present disclosure is applied, the power system uses one connecting component to realize the indirect fixed connection of the arm 16 and the motor 15. As such, the structure of the power system may be simplified, and the connection reliability of the arm 16 and the motor 15 may be improved, thereby improving the convenience of mounting the power system. At the same time, by adjusting from two connecting parts to one connecting part not only reduce the difficult of process preparation, but also avoids the product failure caused by the matching precision of the two parts, thereby effectively reducing the production costs.

An embodiment of the present disclosure further provides a UAV. The UAV may include a body and an arm 16 connected to the body. The arm may be connected to the power system mentioned in the previous embodiments, that is, the connection structure in the power system may receive and fix the arm 16.

In some embodiments, the arm 16 may include, but is not limited to, a carbon tube or an aluminum alloy tube to meet other requirements such as the improved load bearing performance and design appearance.

In addition, in the embodiments of the present disclosure, the outer diameter of the end of the arm 16 received in the receiving sleeve 12 may be slightly smaller than the outer diameter of the end not received in the receiving sleeve 12. As such, after the arm 16 is received in the receiving sleeve 12, the outer surface of the receiving sleeve 12 may be visually integrated with the outer surface of the arm 16.

Those skilled in the art can clearly understand that for the convenience and brevity of description, embodiments of the disclosure are described in a progressive manner. Each embodiment focuses on a difference over other embodiments. The same or similar aspects of the embodiments can be clear by referring to each other.

It should be noted that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A connection structure comprising:
a supporting platform, a first side of the supporting platform being configured to support an electronic speed controller (ESC) and a motor for driving a propeller; and
a receiving sleeve disposed on a second side of the supporting platform and configured to receive and fix an arm.

2. The connection structure of claim 1, wherein:
the supporting platform includes a first mounting surface and a second mounting surface, the first mounting surface being configured to mount the ESC, the second mounting surface being configured to mount the motor; and
a platform height of the first mounting surface is lower than a platform height of the second mounting surface.

3. The connection structure of claim 2, wherein:
the supporting platform includes a supporting body and a plurality of supporting bracket, the plurality of supporting brackets being respectively vertically disposed on opposite sides of the supporting body; and
the first mounting surface is disposed on the supporting body, and the second mounting surface is disposed on the plurality of supporting brackets.

4. The connection structure of claim 3, wherein the plurality of supporting brackets have an inverted L-shaped structure.

5. The connection structure of claim 4, wherein opening directions of the inverted L-shaped structures vertically disposed on the opposite sides of the supporting body face each other.

6. The connection structure of claim 2, wherein:
a first mounting portion is provided on the first mounting surface, the first mounting portion being configured to fix the ESC.

7. The connection structure of claim 6, wherein the first mounting portion is a first screw hole structure.

8. The connection structure of claim 2, wherein:
a second mounting portion is provided on the second mounting surface, the second mounting portion being configured to fix the motor.

9. The connection structure of claim 2, wherein a distance between the first mounting surface and the second mounting surface is greater than a height of the ESC.

10. The connection structure of claim 2, wherein:
the supporting platform further includes a third mounting surface, the third mounting surface surrounds an outer periphery of the first mounting surface; and
the third mounting surface is configured to mount a protective cover for protecting the ESC.

11. The connection structure of claim 10, wherein the protective cover and the third mounting surface form a sealed waterproof structure.

12. The connection structure of claim 10, wherein:
a third mounting portion is provided on the third mounting surface, the third mounting portion being configured to fix the protective cover.

13. The connection structure of claim 12, wherein the third mounting portion is a third screw hole structure.

14. The connection structure of claim 10, wherein the distance between the first mounting surface and the second mounting surface is greater than a height of the protective cover.

15. The connection structure of claim 1, wherein:
the receiving sleeve is clearance-fitted with the arm, and an adhesive is provided between the receiving sleeve and the arm for a fixed connection.

16. The connection structure of claim 1, further comprising:
a heat dissipating structure provided on at least one of an outer periphery of the supporting platform or an outer periphery of the receiving sleeve.

17. A power system comprising:
a propeller;
a motor connected to the propeller;
an electronic speed controller (ESC); and
a connection structure including:
a supporting platform, a first side of the supporting platform being configured to support the ESC and the motor for driving the propeller; and
a receiving sleeve disposed on a second side of the supporting platform and configured to receive and fix an arm.

18. The power system of claim 17, further comprising:
a protective cover, the ESC being disposed in a receiving space of the protective cover.

19. An unmanned aerial vehicle (UAV), comprising:
a main body;
an arm; and
a power system connected to the arm, comprising:
a propeller;
a motor connected to the propeller;
an electronic speed controller (ESC); and
a connection structure including:
a supporting platform, a first side of the supporting platform being configured to support the ESC and the motor for driving the propeller; and
a receiving sleeve disposed on a second side of the supporting platform and configured to receive and fix the arm.

20. The UAV of claim 19, wherein the arm is a carbon tube or an aluminum alloy tube.
